(19) United States
(12) Patent Application Publication
(10) Pub. No.: US 2026/0322642 A1
(43) Pub. Date: Oct. 15, 2026

(54) METHODS AND APPARATUS FOR HANDLING MULTICAST SESSION GROUP NOTIFICATION IN A WIRELESS COMMUNICATION SYSTEM

(71) Applicant: SAMSUNG ELECTRONICS CO., LTD., Suwon-si, Gyeonggi-do (KR)

(72) Inventors: Vinay Kumar SHRIVASTAVA, Bangalore, Karnataka (IN); Sriganesh RAJENDRAN, Bangalore, Karnataka (IN)

(21) Appl. No.: 19/483,946

(22) PCT Filed: May 7, 2024
(86) PCT No.: PCT/KR2024/006094

§ 371 Date: Nov. 12, 2025

(30) Foreign Application Priority Data
May 12, 2023 (IN) 202341033512
Sep. 29, 2023 (IN) 202341065518
Apr. 16, 2024 (IN) 202341033512

(51) Int. Cl. H04L 12/18; H04W 76/27; H04W 76/40

(52) U.S. Cl. CPC H04L 12/185; H04W 76/27; H04W 76/40

(57) ABSTRACT

The disclosure relates to a 5G or 6G communication system for supporting a higher data transmission rate. Embodiments herein is to handler multicast session group notification in telecommunication network system. UE (101) receives one or more paging messages when in an inactive state. Paging messages includes unicast session notification, first multicast session group notification and second multicast session group notification. Further, UE determines whether the first multicast session group notification and the second multicast session group notification is received at same time or in a same paging message, and whether the UE has joined the at least one multicast session corresponding to at least one TMGI. Also, determines whether the paging record list is included in the unicast session notification or whether an UE identity matches with at least one UE identity included in the list of UE identities provided in the unicast session notification. UE transits to connected state, idle state or retains in the inactive state based on unicast session notification, first multicast session group notification and second multicast session group notification.

### TECHNICAL FIELD

This application is based on and derives the benefit of Indian Provisional Application 20/234,1033512 filed on 12 May 2023 and 202341065518 filed on 29 Sep. 2023, the contents of which are incorporated herein by reference. The proposed embodiments relate to the field of telecommunication network. More particularly present disclosure relates to handling multicast session group notification in telecommunication network system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to handling of group notification for multicast UE in a wireless communication systems.

The principal object of the embodiments herein is to handle multicast session group notification in telecommunication network system.

Another object of the invention is to handle simultaneous reception of release 17 group paging and release 18 group paging in a same paging message.

Another object of the invention is to ensure the certain UE to receive multicast session only in connected state when release 18 group paging message is received.

Another object of the invention is to operate UE in connected state upon receiving release 17 and release 18 group paging in paging message.

Another object of the invention is to provide a method for handling concurrent group paging notifications.

### Solution to Problem

In one aspect, the objectives are achieved by providing a method for handling multicast session group notification in a telecommunication network system. The method includes receiving, by a UE, one or more paging messages from a network apparatus when the UE is in an inactive state. The one or more paging messages comprises at least one of a unicast session notification comprising a paging record list that includes list of UE identities, a first multicast session group notification having at least one TMGI corresponding to at least one multicast session associated with the UE, and a second multicast session group notification for the at least one multicast session having an inactive reception allowed parameter corresponding to the at least one of TMGIs included in the first multicast session group notification. Further, the method includes determining, by the UE, whether the first multicast session group notification and the second multicast session group notification is received at same time or in a same paging message, and whether the UE has joined the at least one multicast session corresponding to at least one TMGI. Further, the method includes determining, by the UE, whether the paging record list is not included in the unicast session notification or whether an UE identity of the UE matches with none of the UE identity included in the list of UE identities provided in the unicast session notification. Further, the method includes transiting the UE from the inactive state to a connected state and receiving the at least one multicast session corresponding to the at least one of TMGIs for which the inactive reception allowed parameter is not set. The transition is performed when the first multicast session group notification and the second multicast session group notification are received at the same time or in the same paging message, and the UE has joined the at least one multicast session corresponding to the at least one TMGI, and when the paging record list is not included in the unicast session notification or the UE identity of the UE matches with none of the UE identity included in the list of UE identities provided in the unicast session notification. Also, the method includes continuing the UE in the inactive state and receiving the at least one multicast session corresponding to the at least one of TMGIs for which the inactive reception allowed parameter is set or included in the second multicast session group notification, when the first multicast session group notification and the second multicast session group notification are received at the same time or in the same paging message, and the UE has joined the at least one multicast session corresponding to the at least one TMGI, and the paging record list is not included in the unicast session notification or the UE identity matches with none of the UE identity included in the list of UE identities provided in the unicast session notification.

In an embodiment, the unicast session notification comprises paging record list that includes a list of UE identities associated with plurality of UEs.

In an embodiment, the first multicast session group notification comprises list of TMGIs associated with at least one multicast session.

In an embodiment, the second multicast session group notification comprises the inactive reception allowed parameter for the at least one multicast session reception in inactive state.

In an embodiment, the first multicast session group notification for at least one multicast session is not configured for the UE to be received in inactive state.

In an embodiment, the second multicast session group notification for the at least one multicast session is configured to the UE to be received in inactive state.

In an embodiment, the UE identity of the UE is allocated by at least one of upper layers of the UE or is a fullI-RNTI stored at the UE.

In an embodiment, the method includes determining, by the UE, whether the first multicast session group notification and the second multicast session group notification is received at same time or in a same paging message, and whether the UE has joined the at least one multicast session corresponding to at least one TMGI. Further, the method includes determining, by the UE, whether the paging record list is included in the unicast session notification and whether an UE identity allocated by the upper layers of the UE matches with at least one UE identity included in the list of UE identities provided in the unicast session notification. Further, the method includes transiting the UE to an idle state from the inactive state, when the first multicast session group notification and the second multicast session group notification is received at the same time or in the same paging message and the UE has joined the at least one multicast session having TMGI included in the first multicast session group notification irrespective of the inactive reception allowed parameter included or not included and, the paging record list is included in the unicast session notification and the UE identity allocated by the upper layers of the UE matches with at least one UE identity included in the list of UE identity provided in the unicast session notification.

In an embodiment, the method includes determining, by the UE, whether the first multicast session group notification and the second multicast session group notification is received at same time or in a same paging message, and whether the UE has joined the at least one multicast session corresponding to at least one TMGI. Further, the method includes determining, by the UE, whether the paging record list is included in the unicast session notification and whether an UE identity stored as fullI-RNTI at the UE matches with at least one UE identity included in the list of UE identities provided in the unicast session notification. Further, the method includes transiting the UE from the inactive state to a connected state and receiving the at least one multicast session corresponding to the at least one of TMGIs. The transition to connected state is performed when the first multicast session group notification and the second multicast session group notification are received at the same time or in the same paging message, and the UE has joined the at least one multicast session corresponding to the at least one TMGI irrespective of the inactive reception allowed parameter is included or not included, and when the paging record list is included in the unicast session notification and the UE identity stored as fullI-RNTI at the UE matches with at least one UE identity included in the list of UE identities provided in the unicast session notification.

In an embodiment, the upper layer is at least one of a Non-Access Stratum (NAS) layer, service layer or application layer.

In an embodiment, the method includes determining, by the UE, whether the paging record list is not included in the unicast session notification or whether the UE identity of the UE matches with none of the UE identity included in the list of UE identities provided in the unicast session notification. Further, the method includes determining, by the UE, at least one of whether the UE is not configured with multicast reception in inactive state or whether the UE has not received a multicast session deactivation indication or Point to Multipoint (PTM) configuration for the at least one multicast session joined by the UE in the signaling message, when the paging record list is not included in the unicast session notification or the UE identity of the UE matches with none of the UE identity included in the list of UE identities provided in the unicast session notification. Further, the method includes determining, by the UE, whether inactive reception allowed is included for the at least one multicast session in the paging message. Further, the method includes transiting the UE from the inactive state to connected state when the UE is not configured with multicast reception in inactive state, or the UE has not received a multicast session deactivation indication or PTM configuration for the at least one multicast session joined by the UE in the signaling message irrespective of the inactive reception allowed for the at least one multicast session is included or not included in the paging message. Also, the method includes monitoring Group-Radio Network Temporary Identifier (G-RNTIs) corresponding to the TMGIs in the inactive state, when the UE is configured with multicast reception in inactive state, or the UE has received a multicast session deactivation indication or PTM configuration for the at least one multicast session joined by the UE in the signaling message and the inactive reception allowed for the at least one multicast session is included in the paging message.

In an embodiment, the signaling message is at least one of a RRC release message and a multicast MCCH message.

In an embodiment, transiting the UE from the inactive state to a connected state comprises of initiating a RRC connection resumption procedure.

In an embodiment, the method of transiting the UE to an idle state from the inactive state includes forwarding, by the UE, TMGIs of the at least one multicast session joined by the UE to upper layers, when the paging record list is included in the unicast session notification and the UE identity allocated by the upper layers of the UE matches with at least one UE identity included in the list of UE identity provided in the unicast session notification.

In an embodiment, the UE identity of the UE is allocated by at least one of upper layers of the UE or is a fullI-RNTI stored at the UE.

In an embodiment, a method performed by a user equipment (UE) in a wireless communication system, the method comprising: receiving, from a base station, a paging message in a radio resource control (RRC) inactive state, the paging message including at least one temporary mobile group identity (TMGI) for at least one multicast bradcast services (MBS) session; in case that the UE has joined the at least one MBS session based on the at least one TMGI, identifying whether a list of paging record is included in the paging messaage; and in case that the list of paging record is not included in the paging message, initiating an RRC connection resumption procedure for the at least one MBS session, based on a configuration by the at least one uppler layer.

In an embodiment, a method performed by a base station in a wireless communication system, the method comprising: transmitting, to a user equipment (UE), a paging message in a radio resource control (RRC) inactive state, the paging message including at least one temporary mobile group identity (TMGI) for at least one multicast bradcast services (MBS) session; and in case that the UE has joined the at least one MBS session based on the at least one TMGI, and in case that a list of paging record is not included in the paging message, receiving, from the UE, an RRC connection resumption request message for the at least one MBS session, based on a configuration by the at least one uppler layer.

In an embodiment, a user equipment (UE) in a wireless communication system, the UE comprising: a transceiver; and at least one processor coupled with the transceiver and configured to: receive, from a base station, a paging message in a radio resource control (RRC) inactive state, the paging message including at least one temporary mobile group identity (TMGI) for at least one multicast bradcast services (MBS) session; in case that the UE has joined the at least one MBS session based on the at least one TMGI, identify whether a list of paging record is included in the paging messaage; and in case that the list of paging record is not included in the paging message, initiate an RRC connection resumption procedure for the at least one MBS session, based on a configuration by the at least one uppler layer.

In an embodiment, a base station in a wireless communication system, the base station comprising: a transceiver; and at least one processor coupled with the transceiver and configured to: transmit, to a user equipment (UE), a paging message in a radio resource control (RRC) inactive state, the paging message including at least one temporary mobile group identity (TMGI) for at least one multicast bradcast services (MBS) session; and in case that the UE has joined the at least one MBS session based on the at least one TMGI, and in case that a list of paging record is not included in the paging message, receive, from the UE, an RRC connection resumption request message for the at least one MBS session, based on a configuration by the at least one uppler layer, wherein in case that the list of paging record is included in the paging message, and the UE identity included in a paging record among the list of paging record matches a UE identity allocated by a at least one upper layer, the at least one TMGI is forwarded to the at least one upper layer.

Accordingly, the embodiment herein is to provide a user equipment for handling multicast session group notification in a telecommunication network system. The UE comprises at least one of a processor and a paging handler coupled to the processor. The paging handler is configured to receive one or more paging messages from a network apparatus when the UE is in an inactive state. The one or more paging messages comprises at least one of a unicast session notification comprising a paging record list that includes list of UE identities, a first multicast session group notification having at least one TMGI corresponding to at least one multicast session associated with the UE, and a second multicast session group notification for the at least one multicast session having an inactive reception allowed parameter corresponding to the at least one of TMGIs included in the first multicast session group notification. Further, the paging handler determines whether the first multicast session group notification and the second multicast session group notification is received at same time or in a same paging message, and whether the UE has joined the at least one multicast session corresponding to at least one TMGI. Further, the paging handler determines whether the paging record list is not included in the unicast session notification or whether an UE identity of the UE matches with none of the UE identity included in the list of UE identities provided in the unicast session notification. Further, the paging handler transits the UE from the inactive state to a connected state and receive the at least one multicast session corresponding to the at least one of TMGIs for which the inactive reception allowed parameter is not set. The transition is performed when the first multicast session group notification and the second multicast session group notification are received at the same time or in the same paging message, and the UE has joined the at least one multicast session corresponding to the at least one TMGI, and when the paging record list is not included in the unicast session notification or the UE identity of the UE matches with none of the UE identity included in the list of UE identities provided in the unicast session notification. Further, the paging handler continues the UE in the inactive state and receive the at least one multicast session corresponding to the at least one of TMGIs for which the inactive reception allowed parameter is set (or included) in the second multicast session group notification. The continuation in the inactive state is performed when the first multicast session group notification and the second multicast session group notification are received at the same time or in the same paging message, and the UE has joined the at least one multicast session corresponding to the at least one TMGI, and when the paging record list is not included in the unicast session notification or the UE identity of the UE matches with none of the UE identity included in the list of UE identities provided in the unicast session notification.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

According to an embodiment of the disclosure, a wireless communication can be performed efficiently. Especially, a handling of group notification for multicast UE in a wireless communication systems can be performed efficiently.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates a UE for handling multicast session group notification in telecommunication network system, according to the embodiments as disclosed herein;

FIG. 2 is a flow diagram that illustrates a method for handling multicast session group notification in telecommunication network system, according to the embodiments as disclosed herein; and

FIG. 3 is a flow diagram that illustrates a method for group paging for multicast session activation notification, according to the embodiments as disclosed herein;

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

In general, NR MBS services can refer to multicast services where intended common contents are targeted to a group of User Equipment (UEs) that have joined the multicast services in multicast coverage area and broadcast services where intended contents may be targeted to all the UEs in the broadcast coverage area. The coverage area can be one radio cell or larger.

In the legacy system (i.e. 3GPP Release 17 MBS), for the purpose of informing UEs in the RRC_IDLE state or RRC_INACTIVE state about multicast session “activation”, a group notification or group paging mechanism is utilized. Based on reception of the paging, the UE transits to RRC_CONNECTED state and starts receiving the multicast session. However, there may also be multicast session(s) for the UEs which can be received in the RRC_INACTIVE state (e.g. 3GPP Release 18 MBS may consider such scenario). The motivation to extend the multicast service delivery to RRC_INACTIVE UEs as well is to enhance the capacity of the network to serve more number of UEs. Therefore, there is a need to specify the behavior for the handling of multicast session group notification (e.g. legacy group paging and/or enhanced group paging and/or enhanced MCCH change notification (also termed as multicast MCCH change notification) and enhanced MCCH message (also termed as multicast MCCH message) carrying notification and configuration for multicast session).

A potential issue relates to the UEs that has joined multicast session and when the UE, in the RRC_INACTIVE state, receives legacy group notification, (e.g. legacy group paging) and enhanced multicast session group notification (e.g. enhanced group paging and multicast MCCH change notification and/or multicast MCCH message) at the same time. For example, the UE can receive legacy group paging and enhanced group paging in the same paging message as well. Additionally, in a possible scenario this may also be accompanied with a CN paging or a RAN paging. The behavior of the UE is not clear in this scenario.

Thus, the UE can face a dilemma to handle more than one group notifications received together and therefore, there is a need of a method and system, to address the issue. Currently, there is no method to handle the situations and a method needs to be defined.

Also, in wireless communication and networks, there are certain issues related to following aspects for multicast session activation notification. Some of the issue is how to activate sessions and move selective UEs CONNECTED mode to receive the session while keeping rest of the UEs in INACTIVE state to receive the session. Also, one of the issue is how to handle UE mobility into a cell not supporting MBS session reception in INACTIVE state.

Thus, it is desired to address the above-mentioned disadvantages, issues, or other shortcomings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for handling multicast session group notification in a telecommunication network system. The method includes receiving, by a UE, one or more paging messages from a network apparatus when the UE is in an inactive state. The one or more paging messages comprises at least one of a unicast session notification comprising a paging record list that includes list of UE identities, a first multicast session group notification having at least one TMGI corresponding to at least one multicast session associated with the UE, and a second multicast session group notification for the at least one multicast session having an inactive reception allowed parameter corresponding to the at least one of TMGIs included in the first multicast session group notification. Further, the method includes determining, by the UE, whether the first multicast session group notification and the second multicast session group notification is received at same time or in a same paging message, and whether the UE has joined the at least one multicast session corresponding to at least one TMGI. Further, the method includes determining, by the UE, whether the paging record list is not included in the unicast session notification or whether an UE identity of the UE matches with none of the UE identity included in the list of UE identities provided in the unicast session notification. Further, the method includes transiting the UE from the inactive state to a connected state and receiving the at least one multicast session corresponding to the at least one of TMGIs for which the inactive reception allowed parameter is not set. The transition is performed when the first multicast session group notification and the second multicast session group notification are received at the same time or in the same paging message, and the UE has joined the at least one multicast session corresponding to the at least one TMGI, and when the paging record list is not included in the unicast session notification or the UE identity of the UE matches with none of the UE identity included in the list of UE identities provided in the unicast session notification. Also, the method includes continuing the UE in the inactive state and receiving the at least one multicast session corresponding to the at least one of TMGIs for which the inactive reception allowed parameter is set (or included) in the second multicast session group notification. The continuation is when the paging record list is not included in the unicast session notification or the UE identity of the UE matches with none of the UE identity included in the list of UE identities provided in the unicast session notification.

Accordingly, the embodiments disclose a UE for handling multicast session group notification in a telecommunication network system. The UE comprises at least one of a processor and a paging handler coupled to the processor. The paging handler is configured to receive one or more paging messages from a network apparatus when the UE is in an inactive state. The one or more paging messages comprises at least one of a unicast session notification comprising a paging record list that includes list of UE identities, a first multicast session group notification having at least one TMGI corresponding to at least one multicast session associated with the UE, and a second multicast session group notification for the at least one multicast session having an inactive reception allowed parameter corresponding to the at least one of TMGIs included in the first multicast session group notification. Further, the paging handler determines whether the first multicast session group notification and the second multicast session group notification is received at same time or in a same paging message, and whether the UE has joined the at least one multicast session corresponding to at least one TMGI. Further, the paging handler determines whether the paging record list is not included in the unicast session notification or whether an UE identity of the UE matches with none of the UE identity included in the list of UE identities provided in the unicast session notification. Further, the paging handler transits the UE from the inactive state to a connected state and receive the at least one multicast session corresponding to the at least one of TMGIs for which the inactive reception allowed parameter is not set (or not included). The transition is performed when the first multicast session group notification and the second multicast session group notification are received at the same time or in the same paging message, and the UE has joined the at least one multicast session corresponding to the at least one TMGI, and when the paging record list is not included in the unicast session notification or the UE identity of the UE matches with none of the UE identity included in the list of UE identities provided in the unicast session notification. Further, the paging handler continues the UE in the inactive state and receive the at least one multicast session corresponding to the at least one of TMGIs for which the inactive reception allowed parameter is set (or included) in the second multicast session group notification. The continuation in the inactive state is performed when the UE has joined the at least one multicast session corresponding to the at least one TMGI, and when the paging record list is not included in the unicast session notification or the UE identity of the UE matches with none of the UE identity included in the list of UE identities provided in the unicast session notification.

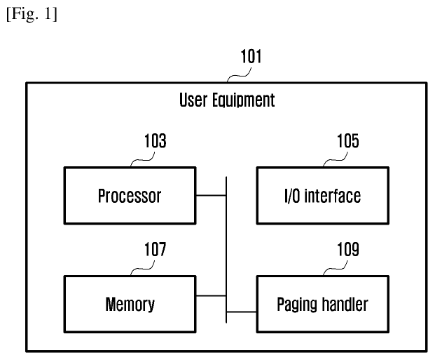

FIG. 1 is a block diagram that illustrates a UE for handling multicast session group notification in telecommunication network system, according to the embodiments as disclosed herein.

The UE (101) includes a processor (103), an I/O interface (105), a memory (107), and a paging handler (109). The UE (101) can be an end-user device that connects with a communication network to access services. For example, the UE (101) can include, but not limited to a mobile phone, a smart phone, tablets, a palmtop, Personal Digital Assistant (PDA), laptops, Internet of Things (IoT), devices a virtual reality device, a television, a connected car, a foldable device, a flexible device, a display device and an immersive system.

Further, the processor (103) of the UE (101) communicates with the memory (107), the I/O interface (105) and the paging handler (109). The processor (103) is configured to execute instructions stored in the memory (107) and to perform various processes. The processor (103) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (107) of the UE (101) includes storage locations to be addressable through the processor (103). The memory (107) is not limited to a volatile memory and/or a non-volatile memory. Further, the memory (107) can include one or more computer-readable storage media. The memory (107) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (107) can store unicast session notification, first multicast session group notification and second multicast session group notification provided in the paging message.

The I/O interface (105) transmits the information between the memory (107) and external peripheral devices. The peripheral devices are the input-output devices associated with the UE (101). The I/O interface (105) can receive paging message from the network apparatus through the I/O interface (105).

The paging handler (109) is an innovative hardware that is realized through the physical implementation of both analog and digital circuits, including logic gates, integrated circuits, microprocessors, microcontrollers, memory circuits, passive and active electronic components, as well as optical components.

The paging handler (109) receives one or more paging messages from a network apparatus when the UE is in an inactive state. The one or more paging messages comprises at least one of a unicast session notification comprising a paging record list that includes list of UE identities, the first multicast session group notification (hereinafter first multicast session group notification is interchangeably used as release 17 group notification) having at least one TMGI corresponding to at least one multicast session associated with the UE (101), and a second multicast session group notification (hereinafter the second multicast session group notification is interchangeably used as Release-18 enhanced group notification approach) for the at least one multicast session having an inactive reception allowed parameter corresponding to the at least one of TMGIs included in the first multicast session group notification. Further, the paging handler (109) determines whether the first multicast session group notification and the second multicast session group notification is received at same time or in a same paging message, and whether the UE (101) has joined the at least one multicast session corresponding to at least one TMGI. Further, the paging handler (109) determines whether the paging record list is not included in the unicast session notification or whether the UE identity of the UE matches with none of the UE identity included in the list of UE identities provided in the unicast session notification. Further, the paging handler (109) transits the UE (101) from the inactive state to a connected state and receives the at least one multicast session corresponding to the at least one of TMGIs for which the inactive reception allowed parameter is not set (or not included). The transition to the connected state is performed when the first multicast session group notification and the second multicast session group notification are received at the same time or in the same paging message, and the UE (101) has joined the at least one multicast session corresponding to the at least one TMGI, and when the paging record list is not included in the unicast session notification or the UE identity matches with none of the UE identity included in the list of UE identities provided in the unicast session notification. Also, the paging handler (109) continues the UE (101) in the inactive state and receives the at least one multicast session corresponding to the at least one of TMGIs for which the inactive reception allowed parameter is set (or included) in the second multicast session group notification. The continuation in the inactive state is performed when the UE (101) has joined the at least one multicast session corresponding to the at least one TMGI, and when the paging record list is not included in the unicast session notification or the UE identity matches with none of the UE identity included in the list of UE identities provided in the unicast session notification.

Accordingly, the embodiment herein is to provide a system and method for group paging User Equipment (UEs) for New Radio Multicast Broadcast Service (NR MBS). The proposed method provides an approach to handle simultaneous reception of group notification for one or more multicast sessions which are configured to the UE (101) to be received in RRC_INACTIVE state (could be Rel-18 enhanced group notification approach) and group notification for one or more multicast sessions which are not configured to the UE (101) to be received in RRC_INACTIVE state (could be Rel-17 group notification approach). Co-existence of the two sets of multicast sessions and associated group notification approaches for the UE (101) in the same cell/network is feasible and needs to be supported.

In an embodiment, multicast session group notification is provided to the UE (101) which is in RRC_INACTIVE state by the network through at least one of the following or one combination of the following:

Legacy group paging e.g. TMGI list is included in the paging message indicating activation for the multicast session(s).

Enhanced group paging e.g. a legacy or a new TMGI list or G-RNTI list is included in the paging message indicating at least one of activation, deactivation, release, configuration change, congestion indication, RRC state change indication for the multicast session(s).

Enhanced MCCH change notification (also termed as multicast MCCH change notification) e.g. includes a downlink control indication (DCI) that schedules the multicast MCCH or a separate DCI that is scheduled by a dedicated RNTI. DCI contains at least one of a bit, bitmap, field or code-point to indicate the at least one of the activation, deactivation, release, configuration change or removal or addition, start of a new multicast session, a change of multicast neighbor cell list, a congestion status indication and so on.

Enhanced MCCH message (also termed as multicast MCCH message) carrying notification and/or configuration for multicast session and/or indication the at least one of the activation, deactivation, release and/or configuration change or removal or addition, a multicast neighbor cell list, a congestion status indication and so on.

### System Information Block (SIB) or a New MBS SIB Termed as SIBx

The approach in a) is also termed as legacy group notification (herein after first multicast session group notification is interchangeably used as legacy group notification) and the approaches in (b to e) are termed as enhanced group notification (herein after second multicast session group notification is interchangeably used as enhanced group notification).

In an embodiment, when the UE (101) in the RRC_INACTIVE state, receives simultaneously the legacy group notification or group paging indicating activation for one or more multicast sessions and the enhanced group notification indicating at least one of the activation, deactivation, release, and configuration change for one or more multicast sessions, the UE (101) determines to trigger RRC connection resumption and transits to RRC_CONNECTED state in accordance with the legacy group notification. Further, UE (101) processes both the received legacy group notification and the received enhanced group notification. Accordingly, UE (101) activates and/or configures the multicast session(s) in the RRC_CONNECTED in accordance with the both the received legacy group notification and the received enhanced group notification. Further, UE (101) deactivates and/or does not configure the multicast session(s) in the RRC_CONNECTED in accordance with the multicast session(s) indicated for deactivation in the received enhanced group notification. Further, UE (101) does not utilize the configuration for the multicast session(s) in the RRC_CONNECTED in accordance with the configuration for the multicast session(s) in the received enhanced group notification. That is, UE (101) newly receives the configuration for the multicast sessions in the RRC_CONNECTED state.

In an embodiment, an example specification text is provided as shown below to illustrate the procedure of enhanced group paging message reception and handling by the UE (101).

Reception of the Paging message by the UE or PagingRecord by the L2 U2N Remote UE:

Upon receiving the Paging message by the UE or receiving PagingRecord from its connected L2 U2N Relay UE by a L2 U2N Remote UE, the UE shall:

| 1> | if in RRC_IDLE, for each of the PagingRecord, if any, included in the Paging | |
|---|---|---|
| | message, or | |
| 1> | if in RRC_IDLE, for each of the PagingRecord, if any, included in the | |
| | UuMessageTransferSidelink message received from the connected L2 U2N | |
| | Relay UE: | |
| | 2> | if the ue-Identity included in the PagingRecord matches the UE identity |
| | | allocated by upper layers: |

| | |
|---|---|
| 3> | if upper layers indicate the support of paging cause: |

| | |
|---|---|
| 4> | forward the ue-Identity, accessType (if present) and paging cause (if |
| | determined) to the upper layers; |

| | |
|---|---|
| 3> | else: |

| | |
|---|---|
| 4> | forward the ue-Identity and accessType (if present) to the upper layers; |

| 1> | if in RRC_INACTIVE, for each of the PagingRecord, if any, included in the | |
|---|---|---|
| | Paging message, or | |
| 1> | if in RRC_INACTIVE, for each of the PagingRecord, if any, included in the | |
| | UuMessageTransferSidelink message received from the connected L2 U2N | |
| | Relay UE: | |
| | 2> | if the ue-Identity included in the PagingRecord matches the UE's stored fullI- |
| | | RNTI: |

| | |
|---|---|
| 3> | if the UE is configured by upper layers with Access Identity 1: |

| | |
|---|---|
| 4> | initiate the RRC connection resumption procedure according to 5.3.13 |
| | with resumeCause set to mps-PriorityAccess; |

| | |
|---|---|
| 3> | else if the UE is configured by upper layers with Access Identity 2: |

| | |
|---|---|
| 4> | initiate the RRC connection resumption procedure according to 5.3.13 |
| | with resumeCause set to mcs-PriorityAccess; |

| | |
|---|---|
| 3> | else if the UE is configured by upper layers with one or more Access |
| | Identities equal to 11-15: |

| | |
|---|---|
| 4> | initiate the RRC connection resumption procedure according to 5.3.13 |
| | with resumeCause set to highPriorityAccess; |

| | |
|---|---|
| 3> | else: |

| | |
|---|---|
| 4> | initiate the RRC connection resumption procedure according to 5.3.13 |
| | with resumeCause set to mt-Access; |

| | |
|---|---|
| NOTE: | A MUSIM UE may not initiate the RRC connection resumption |

procedure, e.g. when it decides not to respond to the Paging message due
to UE implementation constraints as specified in TS 24.501 [23].

| | |
|---|---|
| 2> | else if the ue-Identity included in the PagingRecord matches the UE identity |
| | allocated by upper layers: |

| | |
|---|---|
| 3> | if upper layers indicate the support of paging cause: |

| | |
|---|---|
| 4> | forward the ue-Identity, accessType (if present) and paging cause (if |
| | determined) to the upper layers; |

| | |
|---|---|
| 3> | else: |

| | |
|---|---|
| 4> | forward the ue-Identity and accessType (if present) to the upper layers; |

| | |
|---|---|
| 3> | perform the actions upon going to RRC_IDLE as specified in 5.3.11 with |
| | release cause ‘other’; |

| 1> | if in RRC_IDLE, for each TMGI included in pagingGroupList, if any, included | |
|---|---|---|
| | in the Paging message: | |
| | 2> | if the UE has joined an MBS session indicated by the TMGI included in the |
| | | pagingGroupList: |

| | |
|---|---|
| 3> | forward the TMGI to the upper layers; |

| 1> | if in RRC_INACTIVE and the UE has joined one or more MBS session(s) | |
|---|---|---|
| | indicated by the TMGI(s) included in the pagingGroupList: | |
| | 2> | if PagingRecordList is not included in the Paging message; or |
| | 2> | if none of the ue-Identity included in any of the PagingRecord matches the |
| | | UE identity allocated by upper layers: |

| | |
|---|---|
| 3> | initiate the RRC connection resumption procedure according to 5.3.13 |
| | with resumeCause set as below: |

| | |
|---|---|
| 4> | if the UE is configured by upper layers with Access Identity 1: |
| | 5> set resumeCause to mps-PriorityAccess; |
| 4> | else if the UE is configured by upper layers with Access Identity 2: |
| | 5> set resumeCause to mcs-PriorityAccess; |
| 4> | else if the UE is configured by upper layers with one or more Access |
| | Identities equal to 11-15: |
| | 5> set resumeCause to highPriorityAccess; |
| 4> | else: |
| | 5> set resumeCause to mt-Access; |

| | |
|---|---|
| 2> | else: |

| | |
|---|---|
| 3> | forward the TMGI(s) to the upper layers; |

| 1> | if in RRC_INACTIVE and the UE has joined one or more MBS session(s) | |
|---|---|---|
| | indicated by the TMGI(s) included in the EnhancedpagingGroupList: | |
| | 2> | if pagingGroupList is not included in the Paging message; or |
| | 2> | if there is no TMGI included in the pagingGroupList; or |
| | 2> | if the UE has not joined any MBS session(s) indicated by the TMGI(s) |
| | | included in the pagingGroupList: |

| | |
|---|---|
| 3> | if PagingRecordList is not included in the Paging message; or |
| 3> | if none of the ue-Identity included in any of the PagingRecord matches |
| | the UE identity allocated by upper layers: |

| | |
|---|---|
| 4> | UE stays in RRC_INACTIVE; |

| | |
|---|---|
| 3> | else: |

| | |
|---|---|
| 4> | forward the TMGI(s) to the upper layers; |

| | |
|---|---|
| 2> | else: |

| | |
|---|---|
| 3> | if PagingRecordList is not included in the Paging message; or |
| 3> | if none of the ue-Identity included in any of the PagingRecord matches |
| | the UE identity allocated by upper layers: |

| | |
|---|---|
| 4> | initiate the RRC connection resumption procedure according to 5.3.13 |
| | with resumeCause set as per Access Identity configured by upper |
| | layers; |

| | |
|---|---|
| 3> | else: |

| | |
|---|---|
| 4> | forward the TMGI(s) to the upper layers; |

| 1> | if the UE is acting as a L2 U2N Relay UE, for each of the PagingRecord, if any, | |
|---|---|---|
| | included in the Paging message: | |
| | 2> | if the ue-Identity included in the PagingRecord in the Paging message |
| | | matches the UE identity in sl-PagingIdentityRemoteUE included in sl- |
| | | PagingInfo-RemoteUE received in RemoteUEInformationSidelink message |
| | | from a L2 U2N Remote UE: |

| | |
|---|---|
| 3> | inititate the Uu Message transfer in sidelink to that UE as specified in |
| | 5.8.9.9; |

In an embodiment, the processing of the paging message is completed fully i.e. for all the paging records and the multicast session group notification (e.g. enhanced group paging EnhancedpagingGroupList(s) or multicast MCCH message), before UE (101) performs the transition to the RRC_IDLE state in the case when the UE (101), in RRC_INACTIVE state, receives CN paging (i.e. UE identity allocated by higher layers matches with at least one of the UE identity included in any of the paging record in the paging message) and multicast session group notification (e.g. enhanced group paging or multicast MCCH message) in the same paging message or at the same time.

In an embodiment, the UE (101) in RRC_INACTIVE state, when receives RAN paging (i.e. UE identity stored as fullI-RNTI at the UE matches with at least one of the UE identity included in any of the paging record in the paging message) and multicast session group notification (e.g. enhanced group paging or the multicast MCCH message) in the same paging message or at the same time, UE forwards the at least one of the TMGI which UE (101) has joined and indicated in the EnhancedpagingGroupList in the paging message or the multicast MCCH message. Further, the UE (101) initiates the RRC connection resumption procedure. The UE (101) sends a RRCResumeRequest or RRCResumeRequest1 message with a resumeCause which may be set in accordance with Access Identity configured by the upper layer.

Accordingly, the embodiment herein is to provide a paging approach for multicast session activation notification of Multicast Broadcast Services (MBS) for 5th generation wireless communication system.

In an embodiment, the network configures the UE (101) with the PTM (Point-To-MultiPoint) configuration(s) and/or deactivation indication(s) as part of SuspendConfig of RRCRelease message for one or more multicast sessions which can be received by the UE (101) in RRC_INACTIVE state.

In an embodiment, the network does not configure the UE (101) supporting MBS multicast reception with PTM configuration(s) and/or deactivation indication(s) as part of SuspendConfig of RRCRelease message for one or more multicast sessions, if the network wants the UE to move to RRC_CONNECTED state to receive the respective session(s) upon activation notification in the paging message.

In an embodiment, the network signals an indication (inactiveReceptionAllowed) as part of the group paging for session activation notification to indicate that UEs (101) which has been configured with PTM configuration(s) and/or deactivation indication(s) as part of SuspendConfig of RRCRelease message for that session can continue receiving that MBS session in RRC_INACTIVE state.

In an embodiment, when the network does not include the inactiveReceptionAllowed as part of the group paging for session activation, the UEs (101) upon receiving the group paging will move to RRC_CONNECTED state to receive the MBS session even if it has a valid PTM configuration and/or deactivation indication for the session for the multicast reception in the RRC_INACTIVE state.

In certain cases where the network wants certain UEs (101) to receive the MBS sessions in connected state even if both the network and UE (101) supports MBS session in INACTIVE state. The circumstance can occur in a scenario where the UE (101) is a group leader/talker in a group call/Mission critical call and the leader is supposed to be in CONNECTED mode to have UL/DL traffic and also to maintain QoS (Quality of service) requirements. In such cases the Network would selectively want certain users to move to connected state while rest of the users to remain in INACTIVE state to receive the session. In an embodiment, if the network has not configured INACTIVE state PTM configurations for a session the UE (101) has joined in and the UE (101) is capable of receiving MBS sessions in INACTIVE state, upon receiving a group paging for session activation with inactiveReceptionAllowed indication, the UE (101) initiates RRC Resume procedure and moves to connected to receive the MBS session.

In an embodiment, if the UE (101) receives a group paging notification including inactiveReceptionAllowed for one or more sessions (TMGIs) and UE (101) has joined at least one session (TMGI) in the paging list for which it does not have deactivation indication(s) and/or PTM configuration(s) and/or for multicast reception in the RRC_INACTIVE state, the UE (101) initiates RRC Resume procedure and moves to RRC_CONNECTED state to receive the MBS sessions. For example, UE A has joined sessions S1, S2, S3 and received deactivation indication(s) and/or PTM configuration(s) in RRCRelease with SuspendConfig message for multicast reception in the RRC_INACTIVE state for sessions S2, S3 but not for session S1. Another UE B has joined sessions S2, S3 and received deactivation indication(s) and/or PTM configuration(s) in RRCRelease with SuspendConfig message for multicast reception in the RRC_INACTIVE state for sessions S2, S3. UE A and UE B receives group paging for sessions S1, S2 with inactiveReceptionAllowed for sessions S1 and S2. Then, the UE A resumes the RRC connection so as to avail the multicast sessions in RRC_CONNECTED as the session S1 is not configured for the UE A in RRCRelease with SuspendConfig message. And, the UE B pursues the multicast reception for session S2 in RRC_INACTIVE state.

In an embodiment, if UE (101) is in RRC_INACTIVE and the UE (101) has joined one or more MBS session(s) indicated by the TMGI(s) included in the pagingGroupList received in the paging message, the UE (101) initiates the RRC connection resumption procedure with a relevant resumeCause for at least one of the conditions:
if the UE (101) is not configured with multicast reception in RRC_INACTIVE;
if the UE (101) is not configured with an explicit indication for session deactivation or with PTM configuration in RRCRelease for at least one of the MBS session(s) indicated by the TMGI(s) that the UE (101) has joined; or
if inactiveReceptionAllowed is not included for at least one of the MBS session(s) indicated by the TMGI(s) that the UE (101) has joined.

In an embodiment, when the above conditions (a, b, c) are not met the, UE (101) starts monitoring the G-RNTI(s) corresponding to the TMGI(s) in the RRC_INACTIVE state.

In an embodiment, a procedure text example for the described embodiments is provided as below:

### Example

### 5.3.2.3 Reception of the Paging Message by the UE or PagingRecord by the L2 U2N Remote UE

. . .

| 1> | if in RRC_INACTIVE and the UE has joined one or more MBS session(s) indicated by | |
|---|---|---|
| | the TMGI(s) included in the pagingGroupList: | |
| | 2> | if the UE is not configured with multicast reception in RRC_INACTIVE or if the |
| | | UE is not configured with an explicit indication for session deactivation and/or |
| | | with PTM configuration in RRCRelease for at least one of the MBS session(s) |
| | | indicated by the TMGI(s) that the UE has joined or |
| | | if inactiveReceptionAllowed is not included for at least one of the MBS session(s) |
| | | indicated by the TMGI(s) that the UE has joined: |

| | |
|---|---|
| 3> | if PagingRecordList is not included in the Paging message; or |
| 3> | if none of the ue-Identity included in any of the PagingRecord matches the UE |
| | identity allocated by upper layers or the UE's stored fullI-RNTI: |

| | |
|---|---|
| 4> | initiate the RRC connection resumption procedure according to 5.3.13 |
| | with resumeCause set as below: |

| | |
|---|---|
| 5> | if the UE is configured by upper layers with Access Identity 1: |
| | 6> resumeCause is set to mps-PriorityAccess; |
| 5> | else if the UE is configured by upper layers with Access Identity 2: |
| | 6> resumeCause is set to mcs-PriorityAccess; |
| 5> | else if the UE is configured by upper layers with one or more Access |
| | Identities equal to 11-15: |
| | 6> resumeCause is set to highPriorityAccess; |
| 5> | else: |
| | 6> resumeCause is set to mt-Access; |

| | |
|---|---|
| 3> | else if the ue-Identity included in any of the PagingRecord matches the UE |
| | identity allocated by upper layers: |

| | |
|---|---|
| 4> | forward the TMGI(s) to the upper layers; |

| | |
|---|---|
| 2> | else: |
| 3> | start monitoring the G-RNTI(s) corresponding to the TMGI(s) |

The proposed method and UE (101) primarily concerns on performing actions regarding group paging procedure at UE (101) for session activation. Also, the proposed invention enhances the performance of UE and network multicast data reception. Further, the proposed invention provides an efficient and effective group notification approaches that enable multicast reception in inactive state.

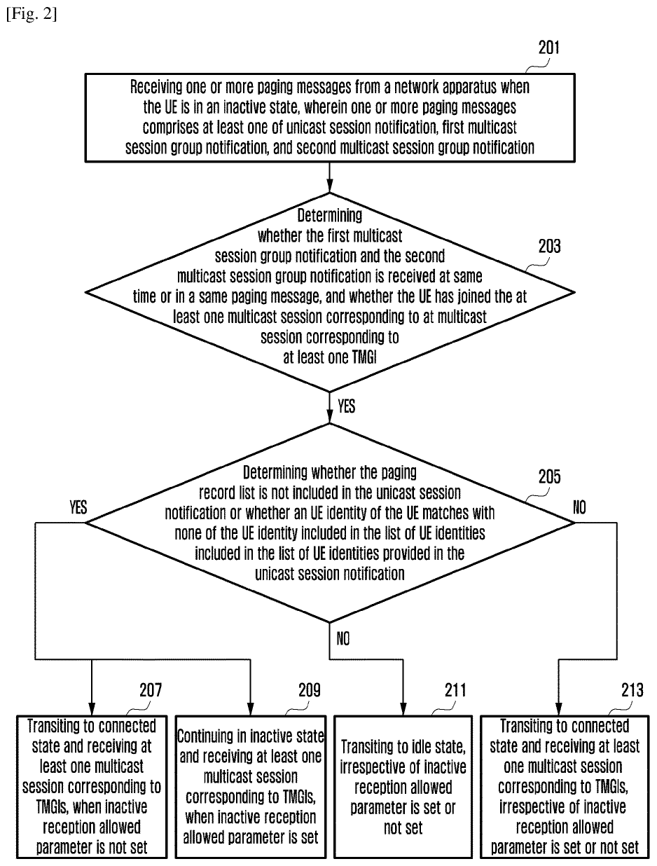

FIG. 2 is a flow diagram that illustrates a method for handling multicast session group notification in telecommunication network system, according to the embodiments as disclosed herein.

At block 201, the paging handler (109) of the UE (101) receives one or more paging messages from the network apparatus when the UE (101) is in the inactive state. The one or more paging messages includes at least one of a unicast session notification, first multicast session group notification, and second multicast session group notification. The unicast session notification includes the paging record list that includes list of UE identities. Also, the first multicast session group notification includes at least one TMGI corresponding to at least one multicast session associated with the UE (101). Also, the second multicast session group notification includes the inactive reception allowed parameter corresponding to the at least one of TMGIs included in the first multicast session group notification.

At block 203, the paging handler (109) determines whether the first multicast session group notification and the second multicast session group notification is the received at same time or in a same paging message and also determines whether the UE (101) has joined the at least one multicast session corresponding to TMGIs included in the first multicast session group notification.

At block 205, the paging handler (109) determines whether paging record list is not included in the unicast session notification or the UE identity of the UE (101) matches with none of the UE identity included in the list of UE identities provided in the unicast session notification. The UE identity of the UE (101) is allocated by at least one of upper layers of the UE (101) or can be a fullI-RNTI stored at the UE (101). The UE identity is allocated by the upper layer, when the UE (101) is paged by the core network (CN). Similarly, the UE identity is a fullI-RNTI when the UE (101) paged by the RAN. The upper layers of the UE (101) can include, but not limited to a Non-Access Stratum (NAS) layer, service layer or application layer.

At block 207, the paging handler (109) transits the UE (101) from the inactive state to the connected state, when the first multicast session group notification and the second multicast session group notification is the received at same time or in a same paging message, inactive reception allowed parameter is not set (or not included) and the UE (101) has joined the at least one multicast session corresponding to TMGIs and the UE (101) has joined the multicast session corresponding to TMGIs included in the first multicast session group notification and the paging record list is not included in the unicast session notification or the UE identity of the UE (101) matches with none of the UE identity included in the list of UE identities provided in the unicast session notification.

At block 209, the paging handler (109) of the UE (101) continues to be in the inactivate state and receives the multicast session corresponding to at least one TMGIs for which the inactive reception allowed parameter is set (or included), when the first multicast session group notification and the second multicast session group notification is the received at same time or in a same paging message, and the UE (101) has joined the at least one multicast session corresponding to TMGIs and the paging record list is not included in the unicast session notification or the UE identity matches with none of the UE identity included in the list of UE identities provided in the unicast session notification.

At block 211, the paging handler (109) transits the UE (101) from the inactive state to the idle state when the paging record list is included in the unicast session notification or the UE identity of the UE (101) matches with at least one UE identity included in the list of UE identities provided in the unicast session notification, where the UE identity is assigned by the upper layers of the UE (101), when the UE (101) has joined the at least one multicast session corresponding to TMGIs included in the first multicast session group notification and irrespective of inactive reception allowed parameter set (or included) or not set (or not included).

At block 213, the paging handler (109) transits the UE (101) from the inactive state to the connected state when the paging record list is included in the unicast session notification or the UE identity of the UE (101) matches with at least one UE identity included in the list of UE identities provided in the unicast session notification, where the UE identity is fullI-RNTI stored at the UE (101), when the UE (101) has joined the at least one multicast session corresponding to TMGIs included in the first multicast session group notification and irrespective of inactive reception allowed parameter set (or included) or not set (or not included).

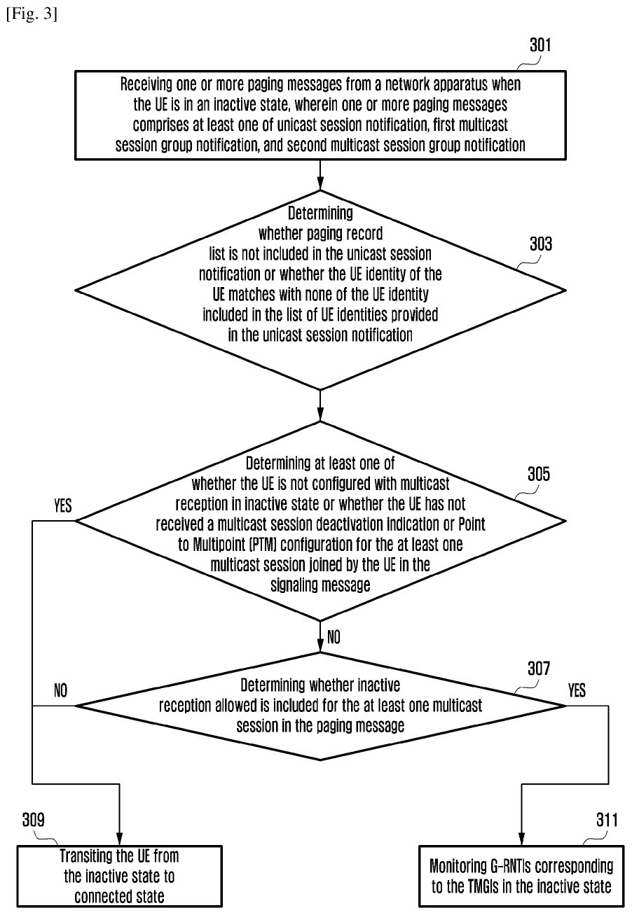

FIG. 3 is a flow diagram that illustrates a method for group paging for multicast session activation notification, according to the embodiments as disclosed herein.

At block 301, the paging handler (109) receives one or more paging messages from the network apparatus when the UE (101) is in the inactive state. The one or more paging messages includes at least one of a unicast session notification, first multicast session group notification, and second multicast session group notification. The unicast session notification includes the paging record list that includes list of UE identities. Also, the first multicast session group notification includes at least one TMGI corresponding to at least one multicast session associated with the UE (101). Also, the second multicast session group notification includes the inactive reception allowed parameter corresponding to the at least one of TMGIs included in the first multicast session group notification.

At block 303, the paging handler (109) determines whether the paging record list is not included in the unicast session notification or whether the UE identity of the UE (101) matches with none of the UE identity included in the list of UE identities provided in the unicast session notification. The UE identity is at least one of allocated by the upper layers or is a fullI-RNTI stored at the UE (101).

At block 305, the paging handler (109) determines at least one of whether the UE (101) is not configured with multicast reception in inactive state or whether the UE has not received a multicast session deactivation indication or Point to Multipoint (PTM) configuration for the at least one multicast session joined by the UE in the signaling message, when the paging record list is not included in the unicast session notification or the UE identity of the UE matches with none of the UE identity included in the list of UE identities provided in the unicast session notification.

At block 307, the paging handler (109) determines whether inactive reception allowed is included for the at least one multicast session in the paging message. If inactive reception allowed is included for the at least one multicast session in the paging message, execution transit to block 311, otherwise, execution transits to block 309.

At block 309, that paging handler (109) transits the UE (101) from the inactive state to the connected state, when the UE (101) is not configured with multicast reception in inactive state, or the UE (101) has not received a multicast session deactivation indication or PTM configuration for the at least one multicast session joined by the UE (101) in the signaling message irrespective of the inactive reception allowed for the at least one multicast session is included or not included in the paging message.

At block 311, the paging handler (109) monitors G-RNTIs corresponding to the TMGIs in the inactive state, when the UE (101) is configured with multicast reception in inactive state, or the UE (101) has received a multicast session deactivation indication or PTM configuration for the at least one multicast session joined by the UE (101) in the signaling message and the inactive reception allowed for the at least one multicast session is included in the paging message.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

List of Reference numerals:

| Reference numerals | Description |
|---|---|
| User Equipment | 101 |
| Processor | 103 |
| I/O interface | 105 |
| Memory | 107 |
| Paging Handler | 109 |

1. A method performed by a user equipment (UE) in a wireless communication system, the method comprising:
receiving, from a base station, a paging message in a radio resource control (RRC) inactive state, the paging message including at least one temporary mobile group identity (TMGI) for at least one multicast bradcast services (MBS) session;
in case that the UE has joined the at least one MBS session based on the at least one TMGI, identifying whether a list of paging record is included in the paging messaage; and
in case that the list of paging record is not included in the paging message, initiating an RRC connection resumption procedure for the at least one MBS session, based on a configuration by the at least one uppler layer.

2. The method of claim 1, further comprising:
identifying whether a UE identity included in a paging record among the list of paging record matches a UE identity allocated by at least one upper layer; and
in case that the list of paging record is included in the paging message, and the UE identity included in the paging record matches the UE identity allocated by the at least one upper layer, forwarding the at least one TMGI to the at least one upper layer.

3. The method of claim 2, further comprising:
in case that none of the UE identity included in the paging record matches the UE identity allocated by at least one upper layer, initiating the RRC connection resumption procedure, based on a configuration by the at least one uppler layer,
wherein the configuration by the at least one uppler layer includes at least one access identity, and
wherein a resume cause to priority access is set, based on the at least one access identity.

4. The method of claim 1, further comprising:
identifying whether a UE identity included in the paging record matches a stored full inactive-radio network temporary identifier (I-RNTI) of the UE; and
in case that the UE identity included in the paging record matches the stored fullI-RNTI of the UE, initiating the RRC connection resumption procedure.

5. A method performed by a base station in a wireless communication system, the method comprising:
transmitting, to a user equipment (UE), a paging message in a radio resource control (RRC) inactive state, the paging message including at least one temporary mobile group identity (TMGI) for at least one multicast bradcast services (MBS) session; and
in case that the UE has joined the at least one MBS session based on the at least one TMGI, and in case that a list of paging record is not included in the paging message, receiving, from the UE, an RRC connection resumption request message for the at least one MBS session, based on a configuration by the at least one uppler layer.

6. The method of claim 5,
wherein in case that the list of paging record is included in the paging message, and the UE identity included in a paging record among the list of paging record matches a UE identity allocated by a at least one upper layer, the at least one TMGI is forwarded to the at least one upper layer.

7. The method of claim 6, further comprising:
in case that none of the UE identity included in the paging record matches the UE identity allocated by at least one upper layer, receiving, from the UE, the RRC connection resumption request message, based on a configuration by the at least one uppler layer, wherein the configuration by the at least one uppler layer includes at least one access identity, and
wherein a resume cause to priority access is set, based on the at least one access identity.

8. The method of claim 5, further comprising:
in case that the UE identity included in the paging record matches a stored full inactive-radio network temporary identifier (I-RNTI) of the UE, receiving, from the UE, the RRC connection request message.

9. A user equipment (UE) in a wireless communication system, the UE comprising:
a transceiver; and
at least one processor coupled with the transceiver and configured to:
receive, from a base station, a paging message in a radio resource control (RRC) inactive state, the paging message including at least one temporary mobile group identity (TMGI) for at least one multicast bradcast services (MBS) session;
in case that the UE has joined the at least one MBS session based on the at least one TMGI, identify whether a list of paging record is included in the paging messaage; and
in case that the list of paging record is not included in the paging message, initiate an RRC connection resumption procedure for the at least one MBS session, based on a configuration by the at least one uppler layer.

10. The UE of claim 9, wherein the at least one processor is further configured to:
identify whether a UE identity included in a paging record among the list of paging record matches a UE identity allocated by at least one upper layer; and
in case that the list of paging record is included in the paging message, and the UE identity included in the paging record matches the UE identity allocated by the at least one upper layer, forward the at least one TMGI to the at least one upper layer.

11. The UE of claim 10, wherein the at least one processor is further configured to:
in case that none of the UE identity included in the paging record matches the UE identity allocated by at least one upper layer, initiate the RRC connection resumption procedure, based on a configuration by the at least one uppler layer,
wherein the configuration by the at least one uppler layer includes at least one access identity, and
wherein a resume cause to priority access is set, based on the at least one access identity.

12. The UE of claim 9, wherein the at least one processor is further configured to:
identify whether a UE identity included in the paging record matches a stored full inactive-radio network temporary identifier (I-RNTI) of the UE; and
in case that the UE identity included in the paging record matches the stored fullI-RNTI of the UE, initiate the RRC connection resumption procedure.

13. A base station in a wireless communication system, the base station comprising:
a transceiver; and
at least one processor coupled with the transceiver and configured to:
transmit, to a user equipment (UE), a paging message in a radio resource control (RRC) inactive state, the paging message including at least one temporary mobile group identity (TMGI) for at least one multicast bradcast services (MBS) session; and
in case that the UE has joined the at least one MBS session based on the at least one TMGI, and in case that a list of paging record is not included in the paging message, receive, from the UE, an RRC connection resumption request message for the at least one MBS session, based on a configuration by the at least one uppler layer, wherein in case that the list of paging record is included in the paging message, and the UE identity included in a paging record among the list of paging record matches a UE identity allocated by a at least one upper layer, the at least one TMGI is forwarded to the at least one upper layer.

14. The base station of claim 13, wherein the at least one processor is further configured to:
in case that none of the UE identity included in the paging record matches the UE identity allocated by at least one upper layer, receive, from the UE, the RRC connection resumption request message, based on a configuration by the at least one uppler layer, wherein the configuration by the at least one uppler layer includes at least one access identity, and
wherein a resume cause to priority access is set, based on the at least one access identity.

15. The base station of claim 13, wherein the at least one processor is further configured to:
in case that the UE identity included in the paging record matches a stored full inactive-radio network temporary identifier (I-RNTI) of the UE, receiving, from the UE, the RRC connection request message.
